(19) United States
(12) Patent Application Publication
(10) Pub. No.: US 2004/0255563 A1
(43) Pub. Date: Dec. 23, 2004

(54) Self-propelled harvesting machine

(75) Inventor: Peter Schafer, Heusweiler (DE)

Correspondence Address: Jimmie R. Oaks, DEERE & COMPANY, Patent Department, One John Deere Place, Moline, IL, 61265-8098, US

(73) Assignee: Deere & Company, a Delaware corporation

(21) Appl. No.: 10/864,686

(22) Filed: Jun. 9, 2004

(30) Foreign Application Priority Data
Jun. 18, 2003 (DE) 103 27 478.2

(51) Int. Cl. A01D 1/00

(52) U.S. Cl. 56/1

(57) ABSTRACT

A self-propelled harvesting machine has a chassis that is supported for travel over the ground by a front pair of propulsion wheels and a single steerable rear wheel. The rear wheel is mounted for being selectively shifted along the direction of operation for changing the spacing between the front wheels and rear wheels so as to effect a difference in the weight distribution between the front and rear wheels. This adjustment can be made automatically in accordance with the weight of a front-mounted harvesting attachment and/or the load imposed on a trailer coupling by a towed trailer.

### FIELD OF THE INVENTION

The invention concerns a self-propelled harvesting machine with a chassis, to which rolling support devices in contact with the ground are attached, which are arranged for the forward propulsion and the steering of the harvesting machine and of which the front set of rolling support devices are arranged ahead of the rear rolling support devices in the direction of operation.

### BACKGROUND OF THE INVENTION

In self-propelled harvesting machines, the load on the wheels and thereby the compaction of the ground are, to a considerable degree, a function of the weight distribution of a front harvesting attachment mounted on the machine and a possible trailer load. In the state of the art, the rear of the machine is ballasted as a function of the type of the front harvesting attachment. Therefore, with relatively heavy front harvesting attachments, a relatively heavy rear ballast must be mounted in order to assure a safe operating performance of the harvesting machine by providing an adequate load on the steerable rear wheels. These measures considerably increase the weight of the harvesting machine, which contributes to the disadvantage of the compaction of the ground. Furthermore, upon a change in the front harvesting attachment, the rear ballast must be changed to conform which results in a not inconsiderable cost in time.

DE 100 04 622 A and AT 285 439 A describe ground level conveyor vehicles with an adjustable wheel base that is used to provide greater stability to the vehicle particularly with higher lifting heights.

The problem underlying the invention is seen in the need to further develop a self-propelled harvesting machine in such a way that the aforementioned disadvantages do not occur or do so only to a lesser degree.

### SUMMARY OF THE INVENTION

According to the present invention, there is provided an improved ground support arrangement for a self-propelled harvesting machine.

It is an object of the invention to provide a harvesting machine including front and rear sets of rolling support devices arranged for the propulsion and steering of the vehicle and wherein at least one of the sets of rolling support devices is mounted for adjustment along the operating direction of the vehicle in order to attain an appropriate distribution of the weight of the machine on the front and rear sets of rolling support devices.

It is proposed that the spacing between the front and the rear sets of rolling support devices in contact with the ground, which may be wheels or crawler track assemblies, be configured as variable by an appropriate arrangement at the chassis of the self-propelled harvesting machine. When wheels are used, the wheel base can thereby be adjusted. As a rule, the front set of rolling support devices are driven and are rigidly connected to the chassis, while the position of the rear rolling support devices, as seen in the forward direction of operation, which are or is, as a rule, steerable, is changed relative to the chassis.

In this way, an accommodation to the weight of the front harvesting attachment used at that time can be attained in each case by a variation of the wheelbase of the harvesting machine. The weight of the harvesting machine can be distributed over the front and the rear sets of rolling support devices in an appropriate manner, so as to achieve a sufficiently heavy loading on the rear rolling support devices, that leads to a good steering ability. Simultaneously, the load on the front rolling support device is reduced, so that the compaction of the ground is lessened. The ballasting of the rear of the harvesting machine may possibly be omitted completely, resulting in a reduction of the total weight of the harvesting machine. Moreover, the set-up time of the harvesting machine is shortened considerably, so that its flexibility is increased.

Basically, it would be conceivable that the aforementioned spacing be provided as input by an operator. The disadvantage here is that inexperienced operators, in particular, could bring about unfavorable operating characteristics of the harvesting machine by erroneous inputs. In a preferred embodiment, an automatic adjustment of the spacing between the front and the rear rolling support devices in contact with the ground is therefore preferred.

The spacing that is to be provided as input is primarily a function of the weight of a front harvesting attachment and a trailer load if a trailer is used. These loads are therefore considered by the arrangement for the readjustment of the spacing. The weight of the front harvesting attachment can be manually input by an operator, or detected by a sensor. The use of an electronic memory unit associated with the front harvesting attachment can also be used for the input of the weight of the front harvesting attachment. The memory unit may be located in a fixed position on the front harvesting attachment and transmit the data over a bus line to the arrangement for the readjustment of the spacing. Alternatively, a memory card or the like can be used that is inserted into an appropriate reading implement. The weight of a trailer load is detected analogously.

If the weight of the front harvesting attachment is to be detected by a sensor, such a sensor can be arranged to measure the hydraulic pressure in the hydraulic circuit of the lifting device of the front harvesting attachment. But measurement with a load cell at the suspension of the front harvesting attachment on the harvesting machine would also be conceivable. Analogously, the support force of a trailer load is preferably detected by a sensor at the trailer coupling.

It should be noted that it would also be conceivable to adjust the position of the rolling ground support devices automatically or manually on the basis of signals from sensors, which detect the weight borne by the rolling support device on the ground.

A change in the spacing between the front and the rear sets of rolling support devices in contact with the ground during the operation poses the danger that the operating and steering performance can change suddenly. An obvious solution therefore is to provide the arrangement for the readjustment of the spacing with information as to the immediate speed of the harvesting machine, that can be detected, for example, by a speed sensor, in order to permit a change in the spacing only when the harvesting machine is stopped.

During operation on public roads, a number of requirements of the law must be fulfilled, that can be met in many cases only when the spacing between the front and the rear sets of rolling support devices in contact with the ground is maintained at a certain value or in a certain range. On the other hand, on the field the spacing can be chosen at will. In a preferred embodiment, the arrangement for the change in the spacing between the front and the rear sets of support devices in contact with the ground can therefore be operated so as to bring the spacing to a certain value, for example, the maximum value, in case the machine is in a public road operating mode.

The public road operating mode can be detected on the basis of the position of a field/public road operating mode switch. Alternatively, or in addition, the position of an electronic selector switch or a mechanical selector lever for the gear ratio of a shifted gearbox of the operating drive of the harvesting machine can be interrogated. On the other hand, if the harvesting machine is on a field, the automatic adjustment of the spacing. is performed as described above.

### BRIEF DESCRIPTION OF THE DRAWINGS

The drawings show an embodiment of the invention that shall be described in greater detail in the following.

FIG. 1 is a left side elevational view of a self-propelled harvesting machine.

FIG. 2 shows a schematic of a arrangement for changing the spacing between the front and the rear rolling support devices in contact with the ground of the harvesting machine.

FIG. 3 shows a flow chart that illustrates the method of operation of the arrangement.

### DESCRIPTION OF THE PREFERRED EMBODIMENT

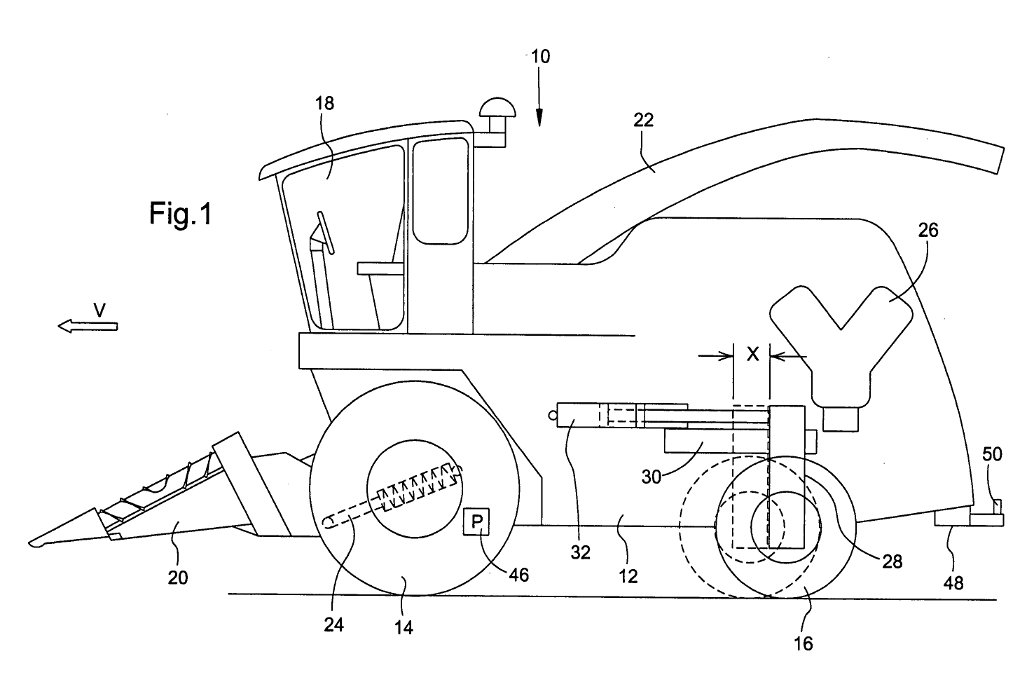

The self-propelled harvesting machine 10 is depicted in the form of a self-propelled forage harvester in FIG. 1 and is supported on a chassis 12 that is carried by a front rolling support device 14 in contact with the ground, in the form of a pair of wheels, and a rear rolling support device 16 in contact with the ground, in the form of a single wheel. The operation of the harvesting machine 10 is controlled by an operator from an operator's cab 18 from which a front harvesting attachment 20 can be controlled within the view of the operator. Besides its application to forage harvesters, the invention can be applied to any desired harvesting machine such as, for example, combines, grape harvesters, cotton harvesters or self-propelled balers.

The front harvesting attachment 20 is attached to the harvesting machine 10 so as to be removable and can be exchanged for any desired front harvesting attachment. Crop taken up from the ground by the front harvesting attachment 20, for example, corn, grass or the like, is conveyed into the interior of the harvesting machine 10 by rough pressing rolls and conducted to a chopper drum that chops it into small pieces and delivers it to a conveyor arrangement. The crop leaves the harvesting machine 10 to an accompanying trailer over a rotating discharge duct 22. The front harvesting attachment 20 is connected in joints to the chassis 12 so as to pivot about the axis of rotation of the chopper drum. The pivoting, that is, the input of the height of the front end of the front harvesting attachment 20 is performed by means of a hydraulic cylinder 24 that extends between the front harvesting attachment 20 and the chassis 12.

An internal combustion engine 26 is located in the rear region of the harvesting machine 10 and supplies the driven elements of the machine 10 with driving energy.

The front set of rolling support devices 14 in contact with the ground are connected rigidly with the chassis 12, that is, they cannot be steered, and can be driven. Optionally, the rear rolling support 16 in contact with the ground is fastened to a suspension 28, whose position in the forward operating direction V in the harvesting machine 10 is variable. For that purpose, the suspension 28 is supported in bearings, free to slide, on a horizontal guide 30 extending in the forward operating direction V and a hydraulic repositioning cylinder 32 extends between the chassis 12 and the suspension 28. Thereby, the wheel base of the harvesting machine 10, that is, the spacing between the rolling support devices 14 and 16 in contact with the ground, can be varied by changing the length of the repositioning cylinder 32. The rear rolling support device 16 can be steered, that is, it can be rotated about a vertical axis, is fastened to the suspension 28 and provides the input of the direction of operation of the harvesting machine 10. For this purpose, a steering cylinder (not shown) is provided that is described, for example, by U.S. Pat. No. 4,222,452, whose disclosure is incorporated in the present application by reference.

An advantage of the use of a single rear wheel lies in the fact that it is offset relative to the front wheels, which contributes to the reduction in the compaction of the ground, and in the smaller steering radius that can be achieved. However, a conventional rear axle with two steerable wheels could also be attached to the harvesting machine 10. Then, the rear axle would be connected with the guide 30 and the repositioning cylinder 32 over the suspension 28.

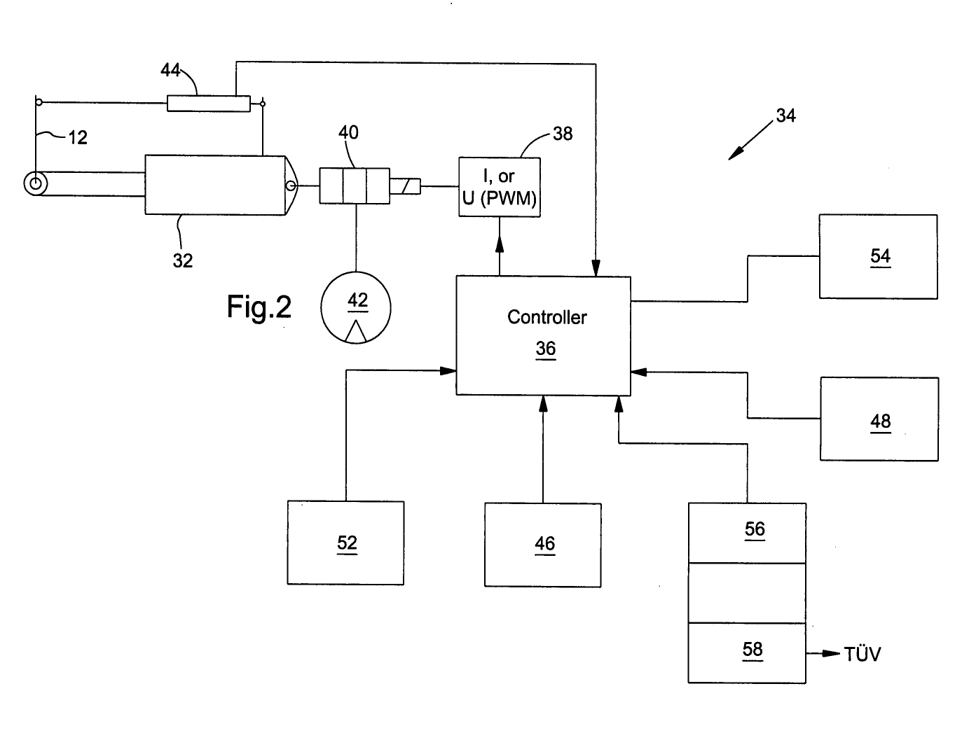

The complete configuration of the arrangement 34 for the variation of the spacing between the front and the rear sets of rolling support devices 14 and 16 is shown schematically in FIG. 2. An electronic control arrangement 36 operating analogously or digitally is connected electrically with a valve control arrangement 38 that controls a proportional control valve 40 as a function of the current or voltage or a pulse-width modulated valve, or any other desired appropriate valve. The proportional control valve 40 is connected with a hydraulic fluid pressure source 42 and with the repositioning cylinder 32. A mechanical position detecting arrangement 44, in the form of a linear potentiometer or any other desired sensor, mounted between the chassis 12 and the suspension 28 provides the control arrangement 36 with information about the immediate position of the suspension 28. Hence, the control arrangement 36 is arranged to control the spacing between the front and rear sets of rolling support devices 14 and 16 while using a feedback signal.

Moreover, the control arrangement 36 is connected with a front harvesting attachment weight sensor 46 that is looped into the hydraulic circuit of the hydraulic cylinder 24 used to reposition the height of the front harvesting attachment 20. The pressure of this hydraulic circuit contains information about the weight of the front harvesting attachment 20 since a higher pressure is required to lift a heavier front harvesting attachment 20 than to lift a lighter front harvesting attachment 20. The part number call-out 52 identifies an input arrangement that can be used as an alternative, or in addition to, the front harvesting attachment weight sensor 46, that permits the operator in the operator's cab 18 to provide as an input the type or the weight or the mass of the front harvesting attachment 20.

The control arrangement 36 also receives an input from a sensor 48 that detects the support force of a trailer that is coupled to a coupling 50 at the rear of the harvesting machine 10. Alternatively, or in addition to the sensor 48, an input arrangement can be used that permits the operator in the operator's cab 18 to provide as an input the type, or the weight or the mass of a trailer at the coupling 50.

A speed sensor 54 detects the actual forward propulsion velocity of the harvesting machine 10. It can interact with one of the sets of rolling support devices 14 and 16 or it may be a radar sensor, that interacts directly with the ground.

Finally, the control arrangement 36 is connected with a gear ratio sensor 56 or a field/public roads operating mode switch 58. The gear ratio sensor 56 detects the gear ratio of a gearbox of the operating drive of the harvesting machine 10 selected at a given time. The field/public roads operating mode switch 58 is located in the operator's cab 18 and is used by the operator to provide an input of the operating mode of the harvesting machine 10. In the public roads operating mode, all elements of the harvesting machine 10 required only for harvesting cannot be activated. Analogously, during operation on a field, only the elements required for harvesting can be turned on, while the elements required for operation on public roads are deactivated.

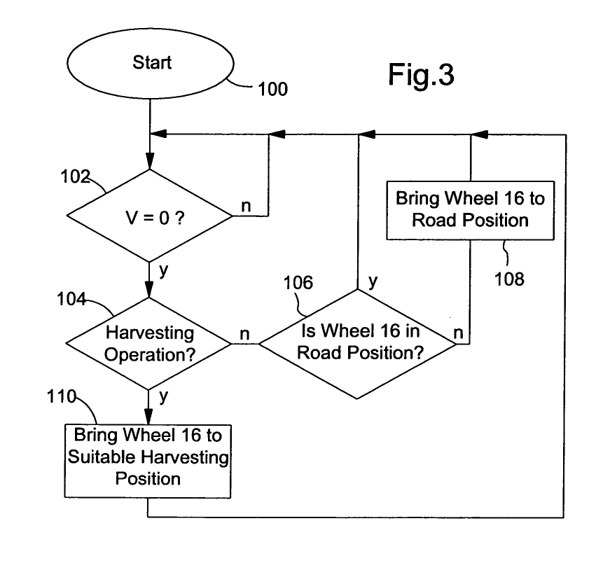

The manner of operating the arrangement is explained in the following on the basis of the flow chart shown in FIG. 3.

After starting in step 100, that is performed after starting the harvesting machine 10, the question is posed initially whether the forward propulsion velocity of the harvesting machine 10 is zero, that is, whether the signal of the speed sensor 54 points to the fact that the machine is stopped. If it is not the case, step 102 again follows. Therefore, a repositioning of the rear rolling support device 16 is not possible during this operation.

Otherwise, step 104 follows in which the gear ratio sensor 56 and/or the field/public roads operating mode switch 58 is interrogated. If the gear ratio sensor 56 determines that the gearbox of the operating drive of the harvesting machine 10 is in its highest gear ratio, the information is taken from it that the harvesting machine 10 is in the public roads operating mode, since this gear ratio is not used during the harvesting operation. On the basis of the field/public roads operating mode switch 58, it is also possible to check whether the harvesting machine 10 is in a harvesting mode or not.

If it is not in a harvesting operation, step 106 follows, in which the question is posed whether the suspension 28 and the rear rolling support device 16 in contact with the ground are in a position for operation on public roads, as permitted by the public roads traffic authorities. If this is the case, step 102 again follows. Otherwise, step 108 follows in which the control arrangement 36 brings the rolling support device 16 into the aforementioned position for the operation on public roads while using the feedback signal of the position detection arrangement 44 and the valve control arrangement 38.

If the result in step 104 shows that the harvesting machine 10 is in a harvesting operating mode, then step 110 follows. On the basis of the signals of the front harvesting attachment weight sensor 46 and of the sensor 48 for the support load on the coupling 50 and optionally the input arrangement 52, the calculation is made into which position the suspension 28 with the rear rolling support device 16 in contact with the ground is to be brought, in order to attain an appropriate weight distribution on the rolling support devices 14 and 16. This appropriate weight distribution is characterized by the fact that a sufficient proportion of the total weight is absorbed by the rear rolling support device 16. Thereby, the compaction of the ground by the front set of rolling support devices 14 is reduced and the result is a good steering performance. Corresponding to the result of the calculation, the position of the suspension 28 is varied. In addition, sensors could be used on the axles of the rolling support devices 14 and 16 in order to recheck the weight distribution attained or to fine tune it: Step 110 is again followed by step 102.

FIG. 3 begins with the premise that the gear ratio of the gearbox of the operating drive can be changed only when the machine is stopped, and that the field/public roads operating mode switch 58 can be adjusted only when the machine is stopped. If these conditions do not apply, the chart in FIG. 3 must be subjected to appropriate modifications in order to prevent an undesired position of the suspension 28 and the rear rolling support device 16 from being attained upon a change in mode of operation of the harvesting machine 10 during operation.

Having described the preferred embodiment, it will become apparent that various modifications can be made without departing from the scope of the invention as defined in the accompanying claims.

1. In a self-propelled harvesting machine including a chassis supported for travel over the ground by front and rear rolling support devices that are arranged for propelling and steering the machine over the ground along a direction of operation, the improvement comprising: a suspension for at least one of said front and rear rolling support devices being mounted to said chassis for adjustment along said direction of operation for changing a spacing between said front and rear rolling support devices so as to change the weight distribution of the harvesting machine on said front and rear rolling support devices.

2. The self-propelled harvesting machine, as defined in claim 1, wherein a powered device is coupled between said chassis and said suspension for selectively effecting said adjustment.

3. The self-propelled harvesting machine, as defined in claim 2, and further including a control arrangement coupled for sending a control signal to said powered device for causing the powered device to effect a change in said spacing in accordance with said control signal; said control arrangement including an operating mode sensing arrangement for sensing whether said self-propelled harvesting machine is in a field operating mode or a public road operating mode and for generating a corresponding input signal; and said control arrangement being responsive to said input signal for sending a control signal to said powered device which limits the spacing between said front and rear rolling support devices to a maximum spacing when said input signal is representative of a public road operating mode.

4. The self-propelled harvesting machine, as defined in claim 3, wherein said operating mode sensing arrangement includes one of an operating mode switch position sensor, or a drive-line gear ratio sensor.

5. The self-propelled harvesting machine, as defined in claim 2, and further including a control arrangement coupled for sending a control signal to said powered device for causing the powered device to effect a change in said spacing in accordance with said control signal; one of a harvesting attachment being mounted to a forward end of said chassis and a trailer coupled for being towed from a trailer coupling at a rear location of said chassis; and a load sensing arrangement associated with said at least one of said harvesting attachment and trailer coupling for generating an input signal respectively representative of a weight of the harvesting attachment or a load imposed on the trailer coupling; and said control arrangement operating in response to said input signal to send a control signal to said powered device for causing the latter to automatically effect a change in said spacing which corresponds to said control signal.

6. The self-propelled harvesting machine, as defined in claim 2, and further including a harvesting attachment mounted to a forward end of said harvesting machine, and said powered device being responsive to a control signal for effecting a change in the spacing between said front and rear rolling support devices; and a control device operatively associated with said powered device and including one of a weight sensor or a stored weight value for generating a control signal, which is a function of a weight of said harvesting attachment, and which is coupled for effecting operation of said powered device so as to effect a change in said spacing between said front and rear rolling support device.

7. The self-propelled harvesting machine, as defined in claim 6, wherein said harvesting attachment is mounted to the forward end of said chassis for pivoting vertically about a horizontal transverse axis; and a hydraulic lift system being coupled between said chassis and said harvesting attachment for positioning said harvesting attachment in a raised position wherein its entire weight is supported by said chassis; and said weight sensor being a sensor which detects the pressure in said lift system.

8. The self-propelled harvesting machine, as defined in claim 3, wherein said control arrangement will send a control signal to said powered device only when said harvesting machine is stopped.

9. In a harvesting machine, as defined in claim 8, wherein said control arrangement includes a sensor for sensing the speed of the harvesting machine and generating a representative speed input signal, and said control arrangement being responsive to said speed input signal for preventing operation of said powered device unless the sensed speed is zero.
